(19) United States
(12) Patent Application Publication
(10) Pub. No.: US 2022/0305724 A1
(43) Pub. Date: Sep. 29, 2022

(54) TRIPLET EXCITON ACCEPTORS FOR INCREASING UPCONVERSION THRESHOLDS FOR 3D PRINTING

(71) Applicant: President and Fellows of Harvard College, Cambridge, MA (US)

(72) Inventors: Daniel N. Congreve, Cambridge, MA (US); Samuel N. Sanders, Cambridge, MA (US)

(73) Assignee: President and Fellows of Harvard College, Cambridge, MA (US)

(21) Appl. No.: 17/618,988

(22) PCT Filed: Jun. 17, 2020
(86) PCT No.: PCT/US20/38057

§ 371 Date: Dec. 14, 2021

Related U.S. Application Data
(60) Provisional application No. 62/864,595, filed on Jun. 21, 2019.
(60) Provisional application No. 62/911,125, filed on Oct. 4, 2019.

(51) Int. Cl. B29C 64/135; B29C 64/106

(52) U.S. Cl. CPC B29C 64/135; B29C 64/106; B33Y 70/00

(57) ABSTRACT

Articles and methods for increasing the triplet upconversion threshold, e.g., by utilizing a triplet exciton acceptor lower in energy than the sensitizer or upconverter, are generally described. Some embodiments, for example, are directed to articles and methods that use a triplet sensitizer, an upconverter, and an acceptor to produce upconverted photons (e.g., light of a second energy). The light can be used to polymerize a polymerizable species. Other upconversion configurations can also be used in other embodiments. In some cases, this may allow true 3D printing to be achieved due to improved control of light absorption, e.g., without needing to “print” on a layer-by-layer basis.

### RELATED APPLICATIONS

This application claims priority under 35 U.S.C. § 119(e) to U.S. Provisional Application No. 62/864,595, filed Jun. 21, 2019, and entitled “TRIPLET EXCITON ACCEPTORS FOR INCREASING UPCONVERSION THRESHOLD FOR 3D PRINTING” and U.S. Provisional Application No. 62/911,125, filed Oct. 4, 2019, and entitled “TRIPLET EXCITON ACCEPTORS FOR INCREASING UPCONVERSION THRESHOLDS FOR 3D PRINTING,” which are incorporated herein by reference in their entirety for all purposes.

### TECHNICAL FIELD

Systems and methods for increasing upconversion thresholds via triplet exciton acceptors are generally described.

### BACKGROUND

Additive manufacturing or “3D printing” finds uses in industries such as prototyping and manufacturing. Several methods of 3D printing are known, but none of these methods truly operate in three dimensions. Instead, these methods use some form of extrusion, either layer by layer in most cases, or continuous withdrawal methods, to photopolymerize a polymer at a liquid-solid interface. The main limitation with these approaches is the inability to truly 3D “print” a pattern because light absorption occurs not only at the desired location, but also at the interface, which can lead to undesired, uncontrolled, or inadequate polymerization. Instead, a very slow interfacial process is used, limiting throughput, practicality, and cost efficiency.

Typical implementations of 3D printing involve a container of liquid and a solid stage where the solid stage is lowered until a short layer of liquid polymer covers the stage. A laser “writes” a pattern onto this thin layer which hardens upon exposure. The stage then lowers further to immerse this material in more liquid, and exposure repeats until the desired structure has been formed. Due to the ability to create arbitrary designs, as well as form shapes that would be difficult to achieve by standard machining techniques, this technique has garnered incredible interest on the market. However, as mentioned, one of the main challenges in this field is that the stepwise printing nature limits printing speed and introduces steps into the surface, as a single layer of material is printed at a time. Thus, improvements in 3D printing technologies are needed.

### SUMMARY

Systems and methods for increasing upconversion thresholds via triplet exciton acceptors are generally described. The subject matter of the present invention involves, in some cases, interrelated products, alternative solutions to a particular problem, and/or a plurality of different uses of one or more systems and/or articles.

In one aspect, a liquid is described. In some cases, the liquid comprises a sensitizer configured to absorb a first energy to form a first triplet state and an upconverter, wherein the upconverter may be configured to receive the first triplet state from the sensitizer to produce a second triplet state. The upconverter may be configured to upconvert the first energy upon interaction with a second upconverter to produce a second energy with the second energy being greater than the first energy. The liquid, in some embodiments, also comprises an acceptor configured to receive the second triplet state from the upconverter, where in some cases, the acceptor comprises a triplet exciton energy lower in energy than the sensitizer and the upconverter, and a polymerizable species configured to receive the second energy from the upconverter to cause polymerization of the polymerizable species to occur.

In another aspect, a liquid is described that comprises a sensitizer configured to absorb a first energy to form a first triplet state, and an upconverter configured for upconversion and configured to receive the first triplet state from the sensitizer to produce a second triplet state for a duration. In some embodiments, the second triplet state decays via upconversion to produce a second energy, where the second energy may be greater than the first energy. The liquid also may comprise an acceptor configured to receive the second triplet state from the upconverter, wherein the acceptor, in some embodiments, reduces the duration of the triplet state of the upconverter and a polymerizable species configured to receive the second energy from the upconverter to cause polymerization of the polymerizable species to occur.

In yet another aspect, a liquid is described, comprising a metal porphyrin having a formula (I):

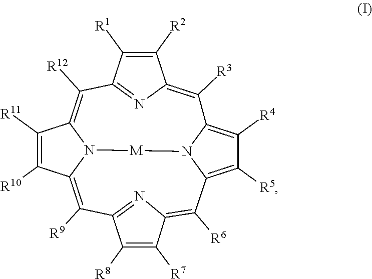

wherein M is selected from the group consisting of platinum, palladium, manganese, and zinc, R³, R⁶, R⁹, R¹² are independently selected from the group consisting of hydrogen, optionally substituted alkyl, optionally substituted aryl, and optionally substituted alkenyl, and R¹ and R², R⁴ and R⁵, R⁷ and R⁸, and R¹⁰ and R¹¹ are independently selected from the group consisting of optionally substituted cycloalkyl and fused aryl or wherein R¹, R², R⁴, R⁵, R⁷, R⁸, R¹⁰, and R¹¹ are independently selected from the group consisting of hydrogen, optionally substituted alkyl, optionally substituted aryl, and optionally substituted alkenyl. The liquid also, in some embodiments, comprise a diphenyl anthracene having a formula (II):

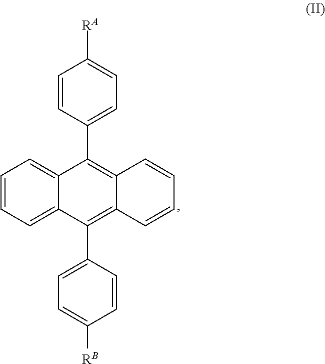

wherein R^{A} and R^{B} are independently selected from the group consisting of optionally substituted alkyl and optionally substituted aryl, and an ethynyl anthracene having a formula (III),

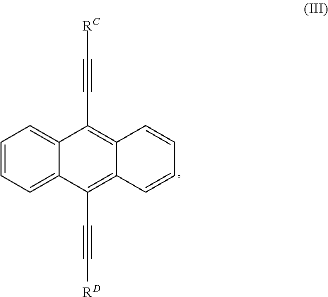

wherein R^{C} and R^{D} are independently selected from the group consisting of optionally substituted alkyl and optionally substituted silyl.

In yet another aspect, a method of 3D printing a polymeric object is described. The method comprises providing a liquid comprising a polymerizable species, a sensitizer, an upconverter, and an acceptor. The method also may comprise focusing at least one laser beam on a focal region of the liquid, wherein at least some of the laser beam with a first energy can be absorbed by the sensitizer. In certain embodiments, the first energy can be transmitted from the sensitizer to the upconverter to produce a triplet state in the upconverter that decays via upconversion to produce a second energy, where the second energy may be greater than the first energy. In some embodiments, the triplet state is absorbed by the acceptor, and the second energy may polymerize the polymerizable species within the focal region to produce a polymeric object. In certain embodiments, substantially no polymerization occurs outside of the focal region of the liquid due to the at least one laser beam. The method also comprises separating the polymeric object from the liquid, at least in certain instances.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a schematic of a liquid configured to increase the upconversion threshold using a triplet exciton acceptor, according to some embodiments;

FIG. 1B shows a schematic of a liquid configured to increase the upconversion threshold using a triplet exciton acceptor, whereby the acceptor receives a triplet state from the sensitizer, according to some embodiments;

FIG. 1C shows a schematic energy level diagram of a sensitizer, an upconverter, and an acceptor, according to some embodiments; and

FIG. 2 shows photoluminescence of diphenyl dihexyl anthracene, according to one set of embodiments.

### DETAILED DESCRIPTION

Articles and methods for increasing the triplet upconversion threshold, e.g., by utilizing a triplet exciton acceptor with a triplet exciton energy lower than the sensitizer or upconverter, are generally described. Some embodiments, for example, are directed to articles and methods that use a triplet sensitizer, an upconverter, and an acceptor to produce upconverted photons (e.g., light of a second energy). The light can be used to polymerize a polymerizable species. Other upconversion configurations can also be used in other embodiments. In some cases, this may allow true 3D printing to be achieved due to improved control of light absorption, e.g., without needing to “print” on a layer-by-layer basis.

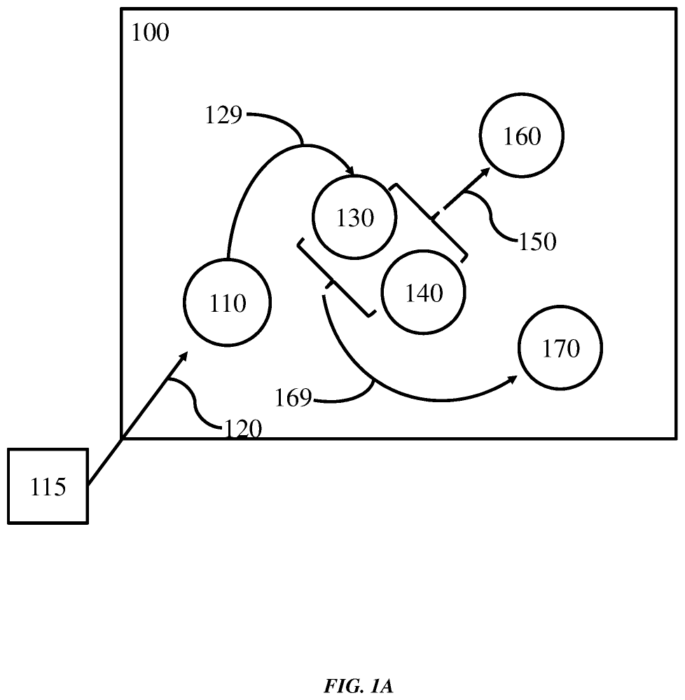

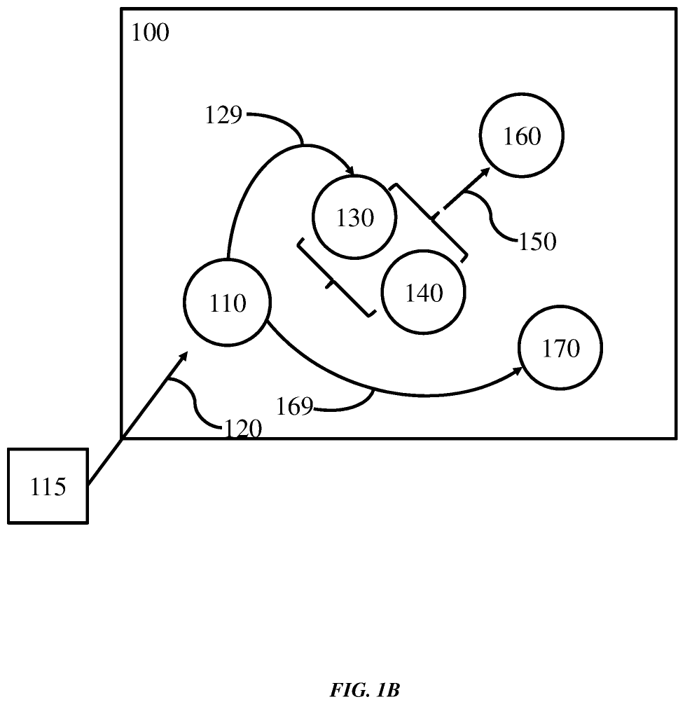

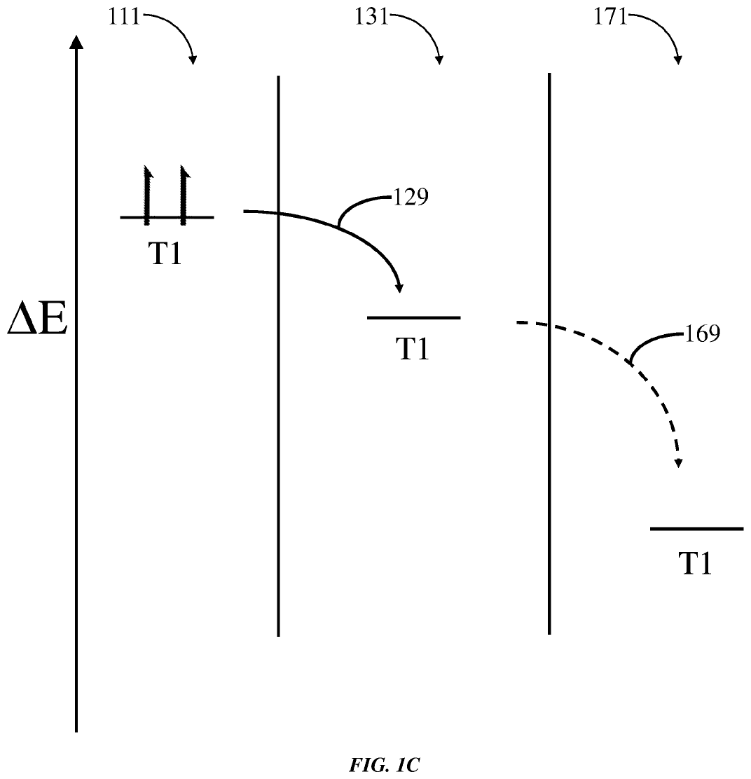

Referring now to FIG. 1A, this figure illustrates a non-limiting example of a liquid configured to produce photons via triplet upconversion. A liquid 100 comprises a sensitizer 110, which may form a triplet state upon photoexcitation (for example by laser 115 with first energy 120) and transfer this triplet state to an upconverter 130, illustrated with arrow 129. Upconverter 130 may then interact with another excited upconverter 140 and undergo triplet-triplet annihilation to produce upconverted photons (i.e., photons of higher energy than the photons used to photoexcite the sensitizer). An acceptor 160 may then receive a triplet state from upconverters 130 and 140 where acceptor 160 has a triplet exciton energy level lower than both the sensitizer 110 and upconverters 130 and 140. Alternatively, an acceptor 170 may receive a triplet state from upconverters 130 or 140 before they collide (not pictured), provided that acceptor 170 has a triplet exciton energy level lower than both the sensitizer 110 and upconverters 130 and 140. Therefore, in some cases, acceptor 170 prevents saturation of the triplet population on the upconverter(s) (e.g., upconverter 130, upconverter 140) until relatively high laser powers, allowing for photon upconversion to remain quadratic relative to the power of laser 115.

In some embodiments, the acceptor is configured to receive the first triplet state from the sensitizer and/or the second triplet state from the upconverter. For example, in FIG. 1A as describe above, acceptor 170 can receive a triplet state from either upconverter 130 or 140 through process 169 (e.g., Dexter transfer). However, in some embodiments, the acceptor is configured to receive a triplet state from the sensitizer. As shown in FIG. 1B, acceptor 170 receives a triplet state sensitizer 110. In some embodiments, the acceptor (e.g., acceptor 170) is configured to receive a triplet state from either an upconverter, a sensitizer, or both.

Accordingly, in certain embodiments, triplet upconversion (or triplet-triplet annihilation, TTA) may be used to produce light of a higher energy relative to light used to photoexcite the sensitizer or the upconverter. In some cases, the addition of a suitable acceptor may slow or prevent two triplet-excited upconverters from undergoing TTA, thereby slowing the process of TTA and hence avoiding saturation of triplet upconverters. This may advantageously allow for an increase in laser power to result in an increase of the rate of TTA (i.e. the upconversion frequency) and thus can allow higher powered lasers to maintain a quadratic or other dependence (e.g., a linear dependence, a dependence higher than quadratic) on the photoluminescence of upconverter as a function of laser power (i.e., upconversion remains second order or higher with respect to the input laser power).

Thus, two photons absorbed by the sensitizer may be combined by the upconverter to produce upconverted photons (e.g., having higher energy) that can be used to cause polymerization of polymerizable entity. In some cases, based on the quadratic dependence of the upconversion process, lasers can be focused on polymerizable entities within a liquid to cause polymerization to occur due to the high number of higher-energy photons produced by the upconversion of the laser light, while elsewhere within the liquid, minimal or no upconversion of light occurs, and thus, no polymerization of the polymerizable entity can occur. This can be used, for example, to achieve true 3D-printing within the liquid, e.g., by focusing one or multiple lasers to illuminate appropriate locations within the liquid, without requiring layer-by-layer printing.

Referring now to FIG. 1C, energy level diagram of the acceptor 171 illustrates that the first excited triplet state of acceptor 170 is lower in energy than the first excited triplet states of the sensitizer 110 and the upconverter 130, seen in energy level diagram of the sensitizer 111 and energy level diagram of the upconverter 131, respectively. It should be understood that polymerization of a polymerizable entity can be controlled by controlling the production of high energy photons, as seen in this diagram, which can be controlled by controlling where light, such as laser light, is applied. This process is highly dependent on where the light is applied (e.g., in a quadratic dependence), and regions where no or limited light is applied (for example, from a single laser, from an unfocused region of the laser) will accordingly not be able to produce high energy photons that can be used for polymerization.

As described above, certain embodiments comprise a liquid. The liquid may be a solvent, such as an organic solvent, that dissolves or otherwise contains the sensitizer, the upconverter, the acceptor, and/or the polymerizable species. These are discussed in more detail below.

In some embodiments, a sensitizer is present, used interchangeably herein with “triplet sensitizer.” As understood by those skilled in the art, a sensitizer (or a triplet sensitizer) can be readily excited to a triplet state (i.e., by a stimulus, such as light, heat, etc.). Without wishing to be bound by theory, the sensitizer may be excited (i.e., by a photon) to produce an excited state sensitizer comprising an excited state singlet, where the excited state singlet may rapidly produce an excited state triplet in the sensitizer via intersystem crossing. The sensitizer can then, for example, transfer an excited state triplet to an upconverter. In some embodiments, the sensitizer is a photosensitizer, which includes compounds that can be efficiently excited to an excited triplet excited state (e.g., a first triplet state, a second triplet state), e.g., using light or electromagnetic radiation. In some cases, the sensitizer may subsequently act as a catalyst in a set of photochemical reaction. In some cases, the sensitizer absorbs low energy light (relative to the energy of the upconverted light) to produce a triplet state that is subsequently transferred to a triplet upconverter, which may then produce high energy light (relative to light incident to the sensitizer). In certain cases, the sensitizer may reach a triplet state upon excitation, e.g., without the need of an additional external stimulus.

In some embodiments, the sensitizer transfers its energy state, e.g., a triplet state (or its corresponding triplet state energy) to an upconverter. The upconverter may be configured to upconvert this energy, as further described below, in some instances. For some embodiments, sensitizers may excite at least two upconverters, such that the two upconverters may undergo triplet-triplet annihilation. And according to some embodiments, the sensitizer may transfer a triplet state and/or corresponding energy to an upconverter.

The sensitizer can also transfer a triplet state to an upconverter (e.g., an emitter) or an acceptor in some embodiments. Without wishing to be bound by any particular theory, the sensitizer can transfer a triplet state by Dexter transfer. Dexter electron transfer (i.e., Dexter transfer, Dexter electron exchange, Dexter energy transfer) is an energy transfer mechanism in which an excited electron is transferred from one molecule (e.g., a sensitizer) to a second molecule (e.g., an upconverter, an acceptor) via a non-radiative path. In some embodiments, a sensitizer transfers a triplet state to an upconverter. Two upconverters can than collide and result in triplet-triplet annihilation and upconverted light. In some embodiments, the sensitizer transfers a triplet state to an acceptor. In some embodiments, an upconverter transfers a triplet state to an acceptor.

A variety of sensitizers may be used in various embodiments. For instance, in some embodiments, the sensitizer comprises a metal porphyrin having a formula (I):

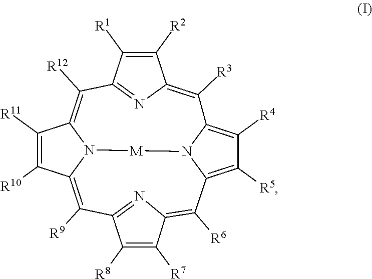

wherein M is selected from the group consisting of platinum, palladium, manganese, and zinc, wherein R³, R⁶, R⁹, R¹² are independently selected from the group consisting of hydrogen, optionally-substituted alkyl, optionally-substituted aryl, and optionally-substituted alkenyl, wherein R¹ and R², R⁴ and R⁵, R⁷ and R⁸, and R¹⁰ and R¹¹ are independently selected from the group consisting of optionally-substituted cycloalkyl and fused aryl, and wherein R¹, R², R⁴, R⁵, R⁷, R⁸, R¹⁰, and R¹¹ are independently selected from the group consisting of hydrogen, optionally-substituted alkyl, optionally-substituted aryl, and optionally-substituted alkenyl. In some embodiments, the sensitizer comprises formula (I). In some cases, the sensitizer comprises an optionally-substituted metal porphyrin. In certain embodiments, the sensitizer is palladium tetraphenyl porphyrin.

In certain embodiments, the sensitizer is palladium tetraphenyl porphyrin. Other sensitizers are possible. Some non-limiting examples of other sensitizers include, but are not limited to, palladium octabutoxy phthalocyanine (PdOBuPc), platinum tetraphenyltetranaphthoporphyrin (PtTPTNP), palladium(II)-meso-tetraphenyl-tetrabenzoporphyrin (PdTPTBP), [Ru(dmb)₃]²⁺ (dmb is 4,4′-dimethyl-2,2′-bipyridine), 2,3-butanedione (biacetyl), palladium(II) tertraanthraporphyrin (PdTAP), platinum(II)tetraphenyltetrabenzoporphyrin (PtTPBP), palladium meso-tetraphenylltetrabenzoporphyrin (PdPh₄TBP), palladium octaethylporphyrin (PdOEP), 11,15,18,22,25 octabutoxyphthalocyanine (PdPc(OBu)₈), platinum octaethylporphyrin (PtOEP), zinc(II) meso-tetraphenylporphine (ZnTPP), [Ru(dmb)₃]²⁺, palladium(II)tetraphenyltetrabenzoporphyrin (PdTPBP), palladium(II) meso-tetraphenyl-octamethoxidetetranaphtholporphyrin (PdPh₄OMe₈TNP), 2-methoxythioxanthone (2MeOTX), and Ir(ppy)₃ (ppy=2-phenylpyridine). Other examples may be possible.

As mentioned above, the sensitizer transfers a triplet state to an upconverter. As understood by those skilled in the art, the term “upconverter” may be used interchangeably with “emitter,” “triplet upconverter,” “annihilator,” and “triplet annihilator.” An upconverter may absorb a triplet state and/or a triplet energy to enter a first excited triplet state of the upconverter. The upconverter, in some embodiments, is configured to undergo upconversion (or triplet upconversion). As understood by those skilled in the art, an upconverter may undergo upconversion (i.e., “triplet upconversion,” “annihilation,” “triplet-triplet annihilation,” “fusion,” “triplet fusion,” etc.) when two upconverters in a triplet excited state collide or otherwise combine their energy to produce a higher energy singlet excited state (relative to the individual energies of the excited upconverters. Alternatively, an upconverter in its triplet excited state may transfer its energy to an acceptor, such as a triplet exciton acceptor, rendering the transferred triplet incapable of performing upconversion. In some cases, an upconverter's second excited states are produced (e.g. a singlet excited state, 51) and subsequently relaxes to its ground state, for example, by emitting the upconverted photon (which can be used, for example, for polymerization of the polymerizable species, or for other applications including those described herein). In some cases, this emission is fluorescence. In some cases, this emission is blue-shifted relative to the excitation light (anti-Stokes emission).

A variety of upconverters are used in different embodiments. As examples, according to certain embodiments, the upconverter comprises a diphenyl anthracene or an optionally-substituted diphenyl anthracene. In certain embodiments, the upconverter comprise a diphenyl anthracene having a formula (II):

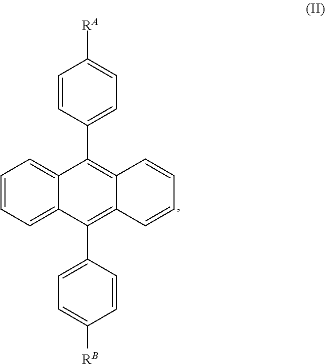

wherein R^{A} and R^{B} are independently selected from the group consisting of optionally-substituted alkyl and optionally-substituted aryl.

In certain embodiments, the upconverter is dihexyl diphenyl anthracene. Other examples are possible. Non-limiting examples of upconverters include 9,10-diphenylanthracene (DPA), TIPS-tetracene (TIPS=triisopropylsilyl), tetra-tert-butylperylene, anthracene (An), 2,5-diphenyloxazole (PPO), rubrene, 2-chloro-bis-phenylethynylanthracene (2CBPEA), 9,10-bis(phenylethnyl)anthracene (BPEA), 9,10-bis(phenylethynyl)napthacene (BPEN), perylene, coumarin 343 (C343), 9,10-dimethylanthracene (DMA), pyrene, tert-butylpyrene, and iodophenyl-bearing boron dipyrromethene (BODIPY) derivatives BD-1 and BD-2. Other upconverters are possible.

Without wishing to be bound by any theory, it is believed that triplet upconversion (or triplet-triplet annihilation, TTA) may be used to produce light of a higher energy relative to light used to photoexcite the sensitizer or the upconverter. TTA refers to the energy transfer mechanism between two molecules (e.g., two upconverters) in their triplet state, and is related to the Dexter energy transfer mechanism. If TTA occurs between two molecules in their excited states, one molecule transfers its excited state energy to the second molecule, resulting in one molecule returning to its ground state and the second molecule being promoted to a higher excited singlet, triplet, or quintet state. Because TTA combines the energy of two triplet excited molecules onto one molecule to produce a higher excited state, it may be used to convert the energy of two photons each of a lower energy into one photon of higher energy (i.e., photon upconversion or triplet upconversion, as described herein). To achieve photon upconversion through triplet-triplet annihilation, two types of molecules may be combined: a sensitizer and an upconverter (i.e., annihilator). The sensitizer absorbs a low energy photon and populates its first excited triplet state (T1) through intersystem crossing. The sensitizer then transfers the excitation energy to the upconverter, resulting in a triplet excited upconverter and a ground state sensitizer. Two triplet-excited upconverters may then undergo triplet-triplet annihilation, and if a singlet excited state (S1) of the upconverter is populated, fluorescence results in an upconverted photon. For certain embodiments, the addition of an acceptor may slow or prevent two triplet-excited upconverters from colliding and undergoing TTA, thereby slowing the process of TTA and hence avoiding saturation of triplet upconverters until higher powers than in the absence of the acceptor, thus increasing the upconversion threshold of the system. Thus, certain embodiments can include acceptors such as those described herein. The inclusion of an acceptor may advantageously allow for an increase in laser power to be used while maintaining a quadratic dependence on the photoluminescence of the upconverter as a function of laser power. In some embodiments, a dependence higher than quadratic (i.e., a second order reaction) is possible.

Thus, according to certain embodiments, an acceptor is present (used interchangeably herein with “triplet acceptor”). The acceptor may have a lowest energy first excited state triplet energy level compared to the sensitizer and the upconverter. By way of illustration and not limitation, FIG. 1C shows schematic energy level diagrams of a sensitizer, an upconverter, and an acceptor according to some embodiments. Energy level diagram of the acceptor 171 shows the first excited triplet state, T1, lower in energy than that of both the sensitizer and the upconverter. Because the energy level of the acceptor is lower than both the sensitizer and the upconverter, the acceptor may advantageously prevent a saturation of excited state triplet upconverters as to maintain a second order dependence in upconversion with respect to the triplet upconverter. In other words, the acceptor may result in some cases in the rate-determining step for upconversion being the collision of two excited state triplet upconverters. The acceptor may perform this by accepting an excited state triplet energy from an upconverter before it undergoes triplet upconversion with another upconverter. As seen in FIG. 1A, for example, acceptor 170 may accept a triplet state from upconverters 130 and 140, illustrated with arrow 169.

According to certain embodiments, the addition of an acceptor may increase the upconversion threshold. The upconversion threshold may, in certain embodiments, refer to the point at which the amount of upconverted light ceases to increase quadratically with input light (e.g., laser light) and begins to increase linearly instead. As described above and without wishing to be bound by any theory, the addition of an acceptor may act to reduce the number of excited upconverters such that the upconversion (or triplet-triplet annihilation) processes remains second order with respected to upconverters and that incident light (i.e., photons) may increase the upconversion frequency. In this case, the upconversion threshold is the point where the process switches from second order to first order with respect to the upconverter, such that incident light (e.g., laser light) no longer increases the upconversion frequency. The upconversion threshold may be measured by plotting photoluminescence versus input power laser power, as illustrated by the Examples below. Other methods of measuring the upconversion threshold are possible.

The acceptor can act as a “triplet sink” with lower triplet energy than either the sensitizer or annihilator, in certain embodiments. Without wishing to be bound by any particular theory, at relatively low laser powers, the triplet sink can effectively collide with sensitizer and/or upconverter triplets to remove energy from the system and prevent upconversion. However, at higher excitation energies, the sink can become saturated with triplet excitons, rendering it ineffective at preventing upconversion. Near the point of triplet sink saturation, the power dependence of upconversion can advantageously be much higher than a second order dependence relative to the power dependence in a system absent the acceptor. This larger power dependence can be useful, for example, to allow higher resolution 3D printing via upconverted light with much simpler optical schemes. For example, larger power dependencies can reduce the numerical aperture (NA) of a 3D printing system using the liquids or methods described herein. Without wishing to be bound by any particular theory, the higher the exponent (e.g., quadratic or higher), the smaller the z-component of the resolution (i.e., along the laser beam). Without a higher than quadratic than quadratic relationship, reliance on a higher NA objective can be needed, which can complicate or limit the optics compared to methods using higher than quadratic laser dependencies as described herein.

In some embodiments, the inclusion of an acceptor (e.g., a triplet sink) can increase the observed intensity dependence of upconversion from quadratic to even higher exponents. That is to say, in some embodiments, the inclusion of an acceptor can increase the order of the upconversion process from first or second order to higher orders (e.g., third order). Without wishing to be bound by any particular theory, the triplet sink can be partially saturated (e.g., saturated with triplet states, saturating at least some, but not all, of the acceptors) effectively at shutting off upconversion at low powers, but when the sink becomes fully saturated at higher powers (e.g., higher laser powers), upconversion by the upconverter becomes more probable to allow upconversion with a higher-than-quadratic dependence.

Different acceptors may be used in various embodiments. In certain embodiments, for example, the acceptor comprises an ethynyl anthracene having a formula (III),

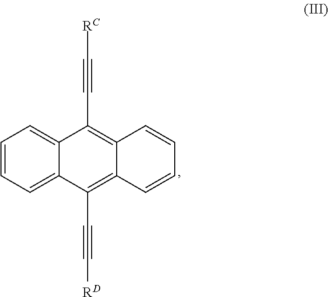

wherein R^{C} and R^{D} are independently selected from the group consisting of optionally substituted alkyl or optionally substituted alkyl comprising silicon. In some embodiments, the acceptor comprises formula (III).

According to certain embodiments, the acceptor comprises an optionally substituted ethynyl anthracene or diethynyl anthracene. In certain embodiments, the acceptor is bisphenyl ethynyl anthracene. Additional non-limiting examples of acceptors may include 9,10-diphenylanthracene (DPA), TIPS-tetracene, tetra-tert-butylperylene, anthracene (An), 2,5-diphenyloxazole (PPO), rubrene, 2-chloro-bis-phenylethynylanthracene (2CBPEA), 9,10-bis(phenylethnyl)anthracene (BPEA), 9,10-bis(phenylethynyl)napthacene (BPEN), perylene, coumarin 343 (C343), 9,10-dimethylanthracene (DMA), pyrene, tert-butylpyrene, and iodophenyl-bearing boron dipyrromethene (BODIPY) derivatives BD-1 and BD-2. Other acceptors may be acceptable as this disclosure is not so limiting.

The sensitizer, the upconverter, and/or the acceptor can be present at any suitable amount or concentration. In some embodiments, the concentration may be expressed as a molar ratio (and/or a mole fraction) of a sensitizer, upconverter, and/or an acceptor. For example, in some cases, the ratio of upconverter to sensitizer is 10:1. In some cases, the ratio of the upconverter to the sensitizer is no more than 100:1, no more than 75:1, no more than 50:1, no more than 25:1, no more than 10:1, no more than 5:1, no more than 3:1, or no more than 1:1, in some cases, the ratio of upconverter to sensitizer is 10:1. In some embodiments, the ratio of the upconverter to the sensitizer is at least 100:1, at least 75:1, at least 50:1, at least 25:1, at least 10:1, at least 5:1, at least 3:1, or at least 1:1. In addition more than one sensitizer, more than one upconverter, and/or more than one acceptor may be present in some embodiments.

In some embodiments, the concentration (of a sensitizer, of an upconverter, of an acceptor, etc.) may be expressed in terms of molar concentration or molarity (M). In some embodiments, the concentration of a sensitizer, an upconverter, and/or an acceptor is at least 5 M, at least 6 M, at least 7 M, at least 8 M, at least 9 M, or at least 10 M. In some embodiments, the concentration of a sensitizer, an upconverter, and/or an acceptor is no greater than 10 M, no greater than 9 M, no greater 8 M, no greater than 7 M, no greater than 6 M, or no greater than 5 M. In some embodiments, the concentration of sensitizer, upconverters, and/or an acceptor is no greater than 1 M, no greater than 0.5 M, no greater than 0.1 M, no greater than 0.01 M, no greater than 0.001 M, no greater than 0.001 M, or less.

In some embodiments, the acceptor is a minority species relative to the sensitizer and/or the upconverter. That is to say, in some embodiments, the concentration of the acceptor is less than the concentration of the emitter and/or the concentration of the upconverter.

In some embodiments, the mole ratio of the acceptor to the upconverter is at least 0.0001, at least 0.001, at least 0.01, at least 0.02, at least 0.05, at least 0.10, at least 0.15 or greater. In some embodiments, the mole ratio of the acceptor to the upconverter is no greater than 0.15, no greater than 0.10, no greater than 0.05, no greater than 0.02, no greater than 0.01, no greater than 0.001, no greater than 0.0001, or less. Combinations of the above-specified ranges are also possible (e.g., at least 0.01 and no greater than 0.15). Other ranges are possible. In some embodiments, the relative amount of the acceptor to the upconverter may be selected such that the upconversion threshold is tuned.

In certain embodiments, the sensitizer, the upconverter, and the acceptor are contained within a liquid, which also may comprise a polymerizable species. A polymerizable species describes a chemical entity capable of undergoing a chemical reaction to produce a polymer, such as plastics, resins, etc. The polymerizable species may be, for example, monomers or other entities that can be polymerized to form a polymer, such as oligomers or other partially-formed polymers. In some cases, light may be used to cause the polymerizable species to polymerize; that is, the polymerizable entities may be photopolymerizable. In some cases, the polymerizable entities may be polymerized to form a polymeric solid object. For certain embodiments, the polymerizable species is a precursor to a polymeric object produced by 3D printing.

In some embodiments, photons produced by the upconversion of two upconverters is used to caused polymerization of the polymerizable species. Referring now to FIG. 1A, for example, upconverters 130 and 140 may interact and/or collide to produce upcoverted photon 150 while transferring a triplet state (illustrated by arrow 169) to acceptor 170, as previously discussed. Photon 150 may then cause the polymerization of polymerizable species 160. Although not pictured, either upconverters 130 or 140 (or both) may be in an excited state, excited by, for example, sensitizer 110.

According to one set of embodiments, the polymerizable species may comprise a resin, such as a 3D printing resin. Examples of 3D printing resins include, but are not limited to, thermoplastics and thermo-solid resins. Many of these are commercially available. Specific non-limiting examples include polyamides, polypropylene, ABS, PLA, PVA, PET, PETT, HIPS, nylon, etc. Additional examples of monomers include vinyl monomers, acrylates, styrenic monomers, and the like. In some cases, the monomer has a double bond, e.g., an alkene. A variety of monomers can be used, e.g., for 3D printing. For instance, examples of acrylates include, but are not limited to, methacrylate, methyl methacrylate, polyacrylates, or the like.

Still other examples of monomers include, but are not limited to, branched polyethylene glycol; linear polyethylene glycol; polyamides and polyamines such as nylon 6, nylon 6,6-poly(pyromellitic dianhydride-co-4,4′-oxydianiline); polyesters 5 such as poly(ethylene terephthalate, poly(4,4′-methylenebis(phenyl isocyanate)-alt-1,4-butanediol/di(propylene glycol)/polycaprolactone); polyethers such as Pluronic®F127, poly(2,6-dimethyl-1,4-phenylene oxide); poly(oxy-1,4-phenylenesulfonyl-1,4-phenylene); silicones such as poly(dimethylsiloxane); vinyl polymers such as HDPE, poly(acrylonitrile-co-butadiene) acrylonitrile, poly(l-(4-(3-carboxy-4-hydroxyphenylazo)benzenesulfonamido)-1,2-ethanediyl, sodium salt), polychloroprene, polyethylene, PMMA, polystyrene, poly(styrene-co-acrylonitrile), polystyrene-block-poly(ethylene-ran-butylene)-block-polystyrene, poly(vinyl acetate); poly(vinyl alcohol), polyvinylpyrrolidone; etc. Other monomers still are also possible.

The liquid containing components such as the sensitizer, the upconverter, and the acceptor may be any suitable liquid. For instance, the liquid may be a solvent, including oleic acid, benzene, toluene, iodobenzene, dichloromethane, acetonitrile, methanol, ethanol, as non-limiting examples, or any organic solvent capable of dissolving or suspending the components of the liquid. The liquid may also be transparent in some cases, e.g., so as to allow light of a certain wavelength or a particular range of wavelengths to pass through the liquid in order to, for example, interact with the sensitizer.

Thus, in some embodiments, the liquid may help to facilitate polymerization of a polymerizable species. For instance, light or other electromagnetic radiation may be focused on specific regions within the liquid that can be upconverted as discussed herein to cause polymerization of a polymerizable species in the liquid in those regions to occur, e.g., while avoiding or minimizing polymerization in other regions of the liquid. Thus, in some cases, the liquid may be one that is optically transparent for a certain set of wavelengths. For example, in embodiments, the liquid is optically transparent to light of a wavelength of 450 nm. In some embodiments, the liquid is optically transparent to light of a wavelength of 1100 nm. In some cases still, the liquid is optically transparent to a wavelength between 450 nm and 1100 nm (e.g. 455 nm, 460 nm, 465 nm, 470 nm, 480 nm, 490 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, 900 nm, 925 nm, 950 nm, 975 nm, 1000 nm, 1025 nm, 1050 nm, 1050 nm, 1075 nm, 1090 nm, 1095 nm, etc.). Other wavelengths outside of 450 nm to 1100 nm may also be possible. Optical transparency may be determined, for example, by taking an absorption spectrum. The transmission of light, or the optical transparency, can be determined as absorbance=2−log(transmittance).

The liquid may have any suitable viscosity. In some cases, the viscosity is relatively low (e.g., similar to water), although in other cases, the viscosity may be higher. For example, relatively high viscosities may be useful to allow relatively fast polymerization of the polymerizable species to form a polymeric object to occur within the liquid or other material, e.g., without the polymeric object being able to drift too far or too quickly away from its initial position, due to the viscosity of the liquid. Thus, in certain embodiments, the polymerizable species may be polymerized into a solid object while free-floating in a liquid. Thus the viscosity of the liquid may be at least about 1 cP, at least about 3 cP, at least about 5 cP, at least about 10 cP, at least about 30 cP, at least about 50 cP, at least about 100 cP, at least about 300 cP, at least about 500 cP, at least about 1,000 cP, at least about 3,000 cP, at least about 5,000 cP, at least about 10,000 cP, at least about 30,000 cP, at least about 50,000 cP, at least about 100,000 cP, etc. In some cases, the viscosity may be less than about 300,000 cP, less than about 100,000 cP, less than about 50,000 cP, less than about 30,000 cP, less than about 10,000 cP, less than about 5,000 cP, less than about 3,000 cP, less than about 1,000 cP, less than about 500 cP, less than about 300 cP, less than about 100 cP, less than about 50 cP, less than about 30 cP, less than about 10 cP, less than about 5 cP, less than about 3 cP, etc. Combinations of any of these ranges are also possible. For example, the viscosity of the liquid may be between 10,000 cP and 300,000 cP.

A variety of techniques or components may be used within the liquid to increase its viscosity. Examples of components that can be added include, but are not limited to, gelatin, xanthan gum or other macromolecules. In some cases, a polymer of the resin itself may be used to increase the viscosity of the liquid. For example, for a methacrylate monomer, a component such as polymethacrylate may be added to the liquid to increase its viscosity. In addition, in some cases, a combination of techniques and/or components may be used.

Thus, in some embodiments, methods of 3D printing a polymeric object is provided, e.g., as discussed above. In some cases, the method includes providing a liquid comprising a polymerizable species, a sensitizer, an upconverter, and an acceptor.

For example, polymerization of the polymerizable species may be facilitated using a laser, e.g., to cause upconversion and the production of higher-energy photons that can be used for polymerization. Thus, in certain embodiments, one or more lasers are present. An example of such a laser is illustrated by laser 115 in FIG. 1A. In some cases, this laser is a part of a 3D printing device. The laser may be the source of photons, e.g., that can be used to cause photoexcitation of the sensitizer and/or the upconverter. The laser may have a particular excitation wavelength, e.g., as discussed below. In some cases, as mentioned, the light or photons produced by upconversion are higher in energy than the excitation wavelength (i.e., its corresponding excitation energy) of the laser. According to certain embodiments, two, three, four, or more lasers may be present, for example, controlled to focus on a location or region within a liquid. In some cases, the light may be directed at the upconversion compositions, e.g., such that the resulting upconverted light is able to initiate polymerization. In some embodiments, as described above, a laser may be the source of the light. For example, the mixture or liquid within a container containing the upconversion materials may be irradiated with light (e.g., laser light) to initiate upconversion and/or to initiate polymerization of the polymerizable species. Suitable wavelengths include, for example, 400 nm to 800 nm, e.g., as the excitation wavelength. As a non-limiting example, upconverted light can be produced locally between 390-500 nm using 532 nm laser light, which is in the range of some common photopolymerization initiators. As another example, light can be applied having a range of between 600 nm and 700 nm, or between 600 nm and 650 nm, which can then be upconverted as discussed herein, e.g., producing shorter wavelengths (or equivalently, higher frequencies or energies). The light may be applied using any suitable light or electromagnetic radiation source, such as a laser or other coherent light source. For example, in one embodiment, the light source is a laser diode, such as those available commercially.

In some embodiments, a laser has a characteristic intensity or power density. For instance, the intensity or power density of the applied electromagnetic radiation applied to the focal point or region to cause polymerization to occur may be less than 5,000 W/cm², less than 3,000 W/cm², less than 2,000 W/cm², less than 1,000 W/cm², less than 500 W/cm², less than 300 W/cm², less than 200 W/cm², less than 100 W/cm², less than 50 W/cm², less than 30 W/cm², less than 20 W/cm², less than 10 W/cm², less than 5 W/cm², less than 3 W/cm², less than 2 W/cm², less than 1 W/cm², less than 500 mW/cm², less than 300 mW/cm², less than 200 mW/cm², less than 100 mW/cm², etc. In some embodiments, the intensity or power density of the applied electromagnetic radiation applied to the focal point or region is related to the upconversion threshold (e.g., the threshold at which triplet-triplet annihilation transitions from second order to first order, the threshold at which triplet-triplet annihilation transitions from quadratic to linear).

The inclusion of an acceptor to a liquid or method can increase the upconversion threshold and the corresponding laser intensity applied to result in upconversion. In some embodiments, the applied electromagnetic radiation (e.g., from a laser) applied to the focal point or region to cause polymerization to occur may be at least 100 mW/cm², at least 500 m W/cm², at least 1 W/cm², at least 10 W/cm², at least 100 W/cm², at least 500 W/cm², at least 1,000 W/cm², at least 5,000 W/cm², at least 10,000 W/cm², at least 20,000 W/cm², at least 30,000 W/cm², at least 40,000 W/cm², at least 50,000 W/cm², or greater.

According to certain embodiments, one, two, or more (i.e., three, four, etc.) laser beams may be focused in at least a portion of a container, e.g., containing a liquid and other components such as those discussed herein. In some cases, the focus of the laser beams may be altered or moved around within the container, which can be used to define an object, e.g., by causing polymerizable entity within the focus to polymerize to produce the object. It should be understood that the focus need not define a contiguous region. For instance, one or more lasers may be turned on and off as necessary to define two, three, four, or more objects within the container. In some embodiments, areas surrounding the focus of the lasers may also receive sufficient light to cause polymerization to occur, e.g., using upconversion as discussed herein. In some embodiments, the area of a spot created by at least one laser beam is at least 300 nm. In some embodiments, the area of a spot created by at least one laser beam is no greater than 1 mm. In some embodiments, the area of a spot created by at least one laser beam is between 300 nm and 1 mm.

Thus, in some embodiments, a method of 3D printing involves focusing at least one laser beam on at least a portion of the liquid, e.g., a focal region, wherein at least some of the laser beam with a first energy is absorbed by the sensitizer. As mentioned above, the sensitizer may absorb a photon. As a non-limiting example, a laser, such as laser 115 in FIG. 1A provides the laser beam of first energy 120 to sensitizer 110.

For certain embodiments, substantially no polymerization occurs outside of the focal region of the laser beam in the liquid, e.g., due to the quadratic dependence of the upconverter as a function of laser power. This may advantageously allow for formation of a polymeric object to occur in specified areas while preventing polymerization in other areas, in certain embodiments. That is to say, in some embodiments, there may be a sharp transition between efficient upconversion at a laser focal point and inefficient upconversion outside the laser focal point since intensity falls off outside the focal point, and upconversion falls superlinearly relative to intensity.

In addition, in some instances, the liquid may comprise additional components. Several of these additional components will be described below.

According to certain embodiments, the liquid may further comprise a micelle-forming agent or micelle-forming molecule. In some embodiments, the micelle-forming agent is a surfactant. In certain embodiments, the micelle-forming agent is oleic acid. The micelle-forming agent may interact with other components comprising the liquid as to form a micelle to encapsulate the components. Non-limiting examples of micelle-forming agents include Triton™ X100, Pluronic® F-127, sodium dodecyl sulfate, and bovine serum albumin.

Certain embodiments use a nanocapsule to encapsulate components within the liquid, e.g., one or more of the sensitizer, the upconverter, and/or the acceptor. The nanocapsule may, in some cases, include a vesicular system made of a membrane or a shall which encapsulates an inner liquid core at the nanoscale. In some embodiments, the shell is a silica-based shell (e.g., SiO₂). A nanocapsule may contain upconversion materials or molecules (e.g., a sensitizer, an upconverter, an acceptor) that can be used to facilitate photon upconversion. The nanocapsules may be contained within a liquid or other within a container of a 3D printing device, which may also contain polymerizable species, cross-linking agents, photopolymerization initiators, or the like, e.g., as discussed herein. Light focused on the nanocapsules may be upconverted to produce wavelengths sufficient to cause polymerization to occur, e.g., as discussed herein. However, in contrast, although other regions within the liquid may receive some light, that light may not be sufficient to be upconverted, and thus, any polymerizable species in those regions would generally not polymerize.

The nanocapsules are typically approximately spherical, and may have an average diameter of less than 1 micrometer, e.g., such that the nanocapsules have an average diameter on the order of nanometers. The nanocapsules, for example, may have an average diameter of less than about 1 micrometer, less than about 900 nm, less than about 800 nm, less than about 700 nm, less than about 600 nm, less than about 500 nm, less than about 400 nm, less than about 300 nm, less than about 200 nm, less than about 100 nm, less than about 90 nm, less than about 80 nm, less than about 70 nm, less than about 60 nm, less than about 50 nm, less than 40 nm, less than about 30 nm, less than about 20 nm, less than about 10 nm, less than about 5 nm, less than about 3 nm, etc. In addition, some cases, the nanocapsules may have an average diameter of at 20 least about 5 nm, at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, etc. In some cases, combinations of any of these are also possible. For example, the nanocapsules may have a diameter between or equal to 30 and 40 nm between 50 nm and 100 nm, between 100 nm and 400 nm, or the like. In addition, it should be understood that in some embodiments, the nanocapsules may be present with a range of sizes or average diameters (i.e., the nanocapsules need not all have precisely the same dimensions), which may include any suitable combination of any of the above-described dimensions.

In some cases, the nanocapsules are smaller than the wavelength of visible light. Nanocapsules having smaller dimensions may be useful in certain embodiments, as they do not substantially interfere with the passage of visible light, thus allowing liquids containing such nanocapsules to appear optically transparent, or to allow visible light to pass without significant scatter.

As mentioned above, the nanocapsules may comprise a silica (SiO₂) shell. This may, for instance, impart some rigidity to the nanocapsules. Such a shell may be formed, for example, upon reaction of a silane (e.g., 3-aminopropyl triethoxysilane) with a silicate (e.g., tetraethyl orthosilicate). The silica shell may also be crosslinked together in certain embodiments. In addition, in some cases, the silicate may comprise a hydrophilic portion (e.g., methoxy polyethylene glycol tetraethyl orthosilicate), such that upon formation of the silica shell, the nanocapsule comprises an outer portion that is relatively hydrophilic (e.g., comprising polyethylene glycol). Such a relatively hydrophilic outer portion may, for example, allow dispersion or dissolution of the nanocapsules in a number of different solvents or liquids. In addition, the relatively hydrophilic portions (e.g., comprising polyethylene glycol units) thus can be covalently linked to the silica shell.

The liquid may also optionally contain one or more photopolymerization initiators according to certain embodiments. The initiators may form free radicals or cations upon initiation. Examples of photopolymerization initiators, but are not limited to, isopropylthioxanthone, benzophenone, 2,2-azobisisobutyronitrile, camphorquinone, diphenyltrimethylbenzoylphosphine oxide (TPO), HCP (1-hydroxycyclohexylphenylketone), B APO (phenyl bis-2,4,6-(trimethylbenzoyl)phosphine oxide), bis(2,6-difluoro-3-(1-hydropyrrol-1-yl)phenyl)titanocene. Other examples include Norrish Type-1 and Norrish Type-2 initiators.

In addition, in some cases, the liquid may also contain one or more cross-linking agents that are able to polymerize with the polymerizable species. Non-limiting examples of crosslinking agents include ethylene glycol dimethacrylate, trimethylolpropane triacrylate, divinylbenzene, N,N′-methylenebisacrylamide, etc.

In certain aspects, the liquid may be contained within a container, and the container may be transparent to light (or other suitable electromagnetic radiation) applied to the liquid. The light may be visible light, ultraviolet light, or other suitable forms of

As mentioned, it should be understood that the photon upconversion materials discussed herein are not limited to only 3D printing applications. Other applications, such as photoredox catalysis chemistry or anti-counterfeiting, are also contemplated as well. For instance, for photoredox catalysis chemistry, the nanocapsules may be used to control delivery of high energy light to a sample. For example, laser light may be applied to a sample that is of a relatively low intensity, long wavelength, etc., but due to the presence of the nanocapsules, that light may be upconverted to a shorter wavelength that can induce a photoredox reaction to occur. In this way, the amount of light applied to the sample may be controlled. This approach may be particularly useful in the event that shorter wavelength light is prone to scatter, either by the reaction medium, by biological tissue, or whatever medium the photoredox chemistry occurs in. In this case, upconversion may be useful in delivering upconverted short wavelength light further into a reaction than is possible by direct illumination at the same wavelength.

Similarly, for anti-counterfeiting, the nanocapsules may be contained within a suitable component (e.g., paper, a polymer, a metal, or the like), and the presence of upconversion may be used to determine whether the component is genuine or counterfeit. Thus, for instance, laser light may be applied to the component, and if the material produces emission of light at shorter wavelengths than the excitation wavelengths (for example, due to the presence of the nanocapsules), the component can be identified as being genuine.

The following are each incorporated herein by reference their entireties: U.S. Pat. Apl. Ser. No. 62/771,996, filed on Nov. 27, 2018, entitled “Photon Upconversion Micelles for 3d Printing and Other Applications” and U.S. Pat. Apl. Ser. No. 62/864,595, filed on Jun. 21, 2019, entitled “Triplet Exciton Acceptors for Increasing Upconversion Threshold 3d Printing.” In addition, a patent application, U.S. Pat. Apl. Ser. No. 62/911,128, filed on Oct. 4, 2019, entitled “Heavy Atom Functionalized Upconverters for Increasing Upconversion Threshold for 3D Printing” by Congreve, et al., is also incorporated herein by reference in its entirety. Furthermore, U.S. Pat. Apl. Ser. No. 62/911,125, filed Oct. 4, 2019, entitled “Triplet Exciton Acceptors for Increasing Upconversion Threshold for 3D Printing,” is incorporated herein by reference in its entirety. Additionally, U.S. Pat. Apl. Ser. No. 63/013,679, filed Apr. 22, 2020, entitled “Heavy Atom-Functionalized Upconverters for Increasing Upconversion Thresholds for 3D Printing,” is incorporated herein by reference in its entirety.

The following examples are intended to illustrate certain embodiments of the present invention, but do not exemplify the full scope of the invention.

### Example 1

Examples of suitable solutions, in accordance with some embodiments of the invention, include (1) saturated solution of PdTPP (palladium tetraphenyl porphyrin) in oleic acid; (2) 1 mg/mL solution of diphenyl dihexyl anthracene; and (3) saturated bisphenyl ethynyl anthracene (BPEA) in oleic acid.

### Example 2

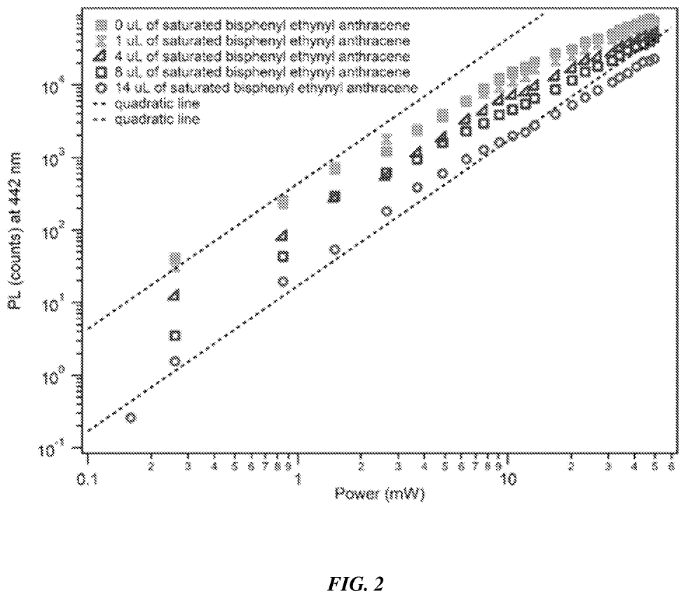

Photoluminescence as a function of input power for continuous wave illumination was probed at a series of excitation powers to produce the plot shown in FIG. 2. While in the control experiment without any biphenyl ethynyl anthracene, the quadratic regime did not persist past 1 mW of input power, when a saturated solution of bisphenyl ethynyl anthracene is added up to 14 uL per mL, the plot of photoluminescence versus power remains quadratic up to ˜10 mW. In the context of 3D printing, this formulation may allow printing at ˜10× higher powers without losing contrast between emission from the focused and unfocused parts of our laser beam.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A liquid, comprising:
a sensitizer configured to absorb a first energy to form a first triplet state;
an upconverter, wherein the upconverter is configured to receive the first triplet state from the sensitizer to produce a second triplet state, and wherein the upconverter is configured to upconvert the first energy upon interaction with a second upconverter to produce a second energy, the second energy being greater than the first energy;
an acceptor configured to receive the second triplet state from the upconverter, wherein the acceptor comprises a triplet exciton energy lower in energy than the sensitizer and the upconverter; and
a polymerizable species configured to receive the second energy from the upconverter to cause polymerization of the polymerizable species to occur.

2. A liquid, comprising:
a sensitizer configured to absorb a first energy to form a first triplet state;
an upconverter, wherein the upconverter is configured to receive the first triplet state from the sensitizer to produce a second triplet state, and wherein the upconverter is configured to upconvert the first energy upon interaction with a second upconverter to produce a second energy, the second energy being greater than the first energy;
an acceptor configured to receive the first triplet state from the sensitizer or the second triplet state from the upconverter, wherein the acceptor comprises a triplet exciton energy lower in energy than the sensitizer and the upconverter; and
a polymerizable species configured to receive the second energy from the upconverter to cause polymerization of the polymerizable species to occur.

3. A liquid, comprising:
a sensitizer configured to absorb a first energy to form a first triplet state;
an upconverter configured for upconversion and configured to receive the first triplet state from the sensitizer to produce a second triplet state for a duration, wherein the second triplet state decays via upconversion to produce a second energy, the second energy being greater than the first energy;
an acceptor configured to receive the second triplet state from the upconverter, wherein the acceptor reduces the duration of the triplet state of the upconverter; and
a polymerizable species configured to receive the second energy from the upconverter to cause polymerization of the polymerizable species to occur.

4. A liquid, comprising:
a metal porphyrin having a formula (I): 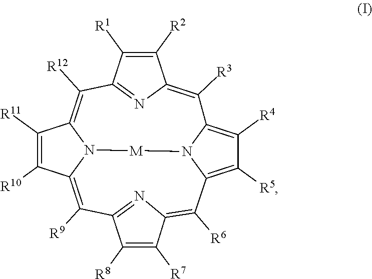
wherein M is selected from the group consisting of platinum, palladium, manganese, and zinc, wherein R³, R⁶, R⁹, R¹² are independently selected from the group consisting of hydrogen, optionally substituted alkyl, optionally substituted aryl, and optionally substituted alkenyl, wherein R¹ and R², R⁴ and R⁵, R⁷ and R⁸, and R¹⁰ and R¹¹ are independently selected from the group consisting of optionally substituted cycloalkyl and fused aryl, and wherein R¹, R², R⁴, R⁵, R⁷, R⁸, R¹⁰, and R¹¹ are independently selected from the group consisting of hydrogen, optionally substituted alkyl, optionally substituted aryl, and optionally substituted alkenyl;
a diphenyl anthracene having a formula (II): 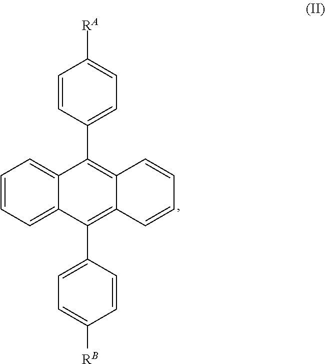
wherein R^{A} and R^{B} are independently selected from the group consisting of optionally substituted alkyl and optionally substituted aryl; and
an ethynyl anthracene having a formula (III), 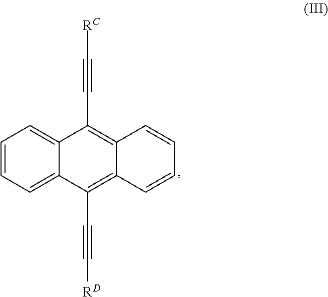
wherein R^{C} and R^{D} are independently selected from the group consisting of optionally substituted alkyl and optionally substituted silyl.

5. The liquid of any one of the preceding claims, wherein the liquid emits blue-shifted light relative to a light incident.

6. The liquid of any one of the preceding claims, wherein the liquid emits anti-Stokes emission upon irradiation.

7. The liquid of any preceding one of the preceding claims, wherein the liquid further comprises a molecule configured to form a micelle when exposed to water.

8. The liquid of any one of the preceding claims, further comprising oleic acid.

9. The liquid of any one of the preceding claims, further comprising a silicate and/or a silicon compound.

10. The liquid of any one of the preceding claims, wherein the sensitizer comprises palladium tetraphenyl porphyrin.

11. The liquid of any one of the preceding claims, wherein the upconverter comprises dihexyl diphenyl anthracene.

12. The liquid of any one of the preceding claims, wherein the acceptor comprises bisphenyl ethynyl anthracene.

13. The liquid of any one of the preceding claims, wherein the liquid is incorporated in a nanocapsule.

14. A method of 3D printing a polymeric object, the method comprising:
providing a liquid comprising a polymerizable species, a sensitizer, an upconverter, and an acceptor;
focusing at least one laser beam on a focal region of the liquid, wherein at least some of the laser beam with a first energy is absorbed by the sensitizer, wherein the first energy is transmitted from the sensitizer to the upconverter to produce a triplet state in the upconverter that decays via upconversion to produce a second energy, the second energy being greater than the first energy, wherein the triplet state is absorbed by the acceptor, and wherein the second energy polymerizes the polymerizable species within the focal region to produce a polymeric object, and wherein substantially no polymerization occurs outside of the focal region of the liquid due to the at least one laser beam; and
separating the polymeric object from the liquid.

15. The method of any preceding claim, wherein a laser power is at least 1 mW/cm².

16. The method of any preceding claim, wherein polymerization occurs substantially only within the intersecting region.

17. The method of any preceding claim, wherein polymerization occurs only near the vicinity of the intersecting region.

18. The method of any preceding claim, wherein decay to produce the second energy remains second order with respect to the upconverter during the method.

19. The method of any preceding claim, wherein the liquid further comprises a molecule configured to form a micelle when exposed to water.

20. The method of any preceding claim, wherein the liquid further comprises a silicate and/or a silicon compound.

21. The method of any preceding claim, further comprising partially saturating the acceptor.

22. The method of any preceding claim, wherein the focusing step provides an observed intensity dependence of upconversion of quadratic or higher order.
